(19) United States
(12) Patent Application Publication
(10) Pub. No.: US 2025/0270979 A1
(43) Pub. Date: Aug. 28, 2025

(54) Method for providing wind data

(71) Applicant: Wobben Properties GmbH, Aurich (DE)

(72) Inventors: Frederik Berger, Oldenburg (DE); Milan Damminger, Templin (DE); Tim Homeyer, Oldenburg (DE); Michael Brüdgam, Aurich (DE)

(73) Assignee: Wobben Properties GmbH, Aurich (DE)

(21) Appl. No.: 19/064,254

(22) Filed: Feb. 26, 2025

(30) Foreign Application Priority Data
Feb. 27, 2024 (EP) 24160108.7

(51) Int. Cl. F03D 7/04; G01W 1/10

(52) U.S. Cl. CPC F03D 7/048; G01W 1/10; F05B 2260/84; F05B 2270/32

(57) ABSTRACT

The present disclosure is directed to method for providing wind data at a prediction location includes providing training data sets for a plurality of installation locations for wind turbines, wherein the training data sets are obtained from public databases, preparing the training data sets for machine learning by transforming the training data sets into features, training a prediction model for predicting at least one statistical wind condition at the location based on the features, obtaining a target location, in particular from a Customer Relationship Management (CRM) system, predicting the at least one statistical wind condition at the target location using the trained prediction model, and providing wind data including the predicted at least one statistical wind condition to the CRM system.

### TECHNICAL FIELD

The present disclosure relates to a method for providing wind data at a prediction location.

### BACKGROUND

Wind turbines are known. The efficiency of wind turbines at specific locations depends decisively on the wind conditions prevailing there. Different turbine configurations are suitable for different wind conditions, so that the wind conditions are preferably already known before wind turbines are set up.

At the same time, the wind turbines at specific installation locations must not experience excessive loads which endanger the integrity and stability of the wind turbine.

Bilgili et al., in the article “Application of artificial neural networks for the wind speed prediction of target station using reference stations data” from the Journal Renewable Energy 32, from the year 2007 on pages 2350-2360, ISSN: 0960-1481, DOI: 10.1016/J.RENENE.2006.12.001, describe the use of artificial neural networks (ANNs) in order to predict the average monthly wind speed of any target station on the basis of the average monthly wind speeds of adjacent stations which are specified as reference stations. Ehsan M D Amimul et al., in the article “Wind Speed Prediction and Visualization Using Long Short-Term Memory Networks (LSTM)”, within the framework of the 2020 10TH INTERNATIONAL CONFERENCE ON INFORMATION SCIENCE AND TECHNOLOGY (ICIST), IEEE, of 9 Sep. 2020 (2020-09-09), pages 234-240, XP033829895, DOI: 10.1109/ICIST49303.2020.9202300, describe the prediction of the wind speed by machine learning algorithm which simplifies the planning of wind farms and feasibility studies. Twelve artificial intelligence algorithms were tested for the prediction of the wind speed from meteorological parameters. The performances of the models were compared in order to determine the accuracy of the wind speed prediction.

EP 2 148 225 B1 describes a method for predicting wind resources for a wind farm, wherein the prediction is carried out by a numerical weather prediction tool, wherein the weather prediction tool uses a long-term data record from meteorological data which relate to the location of the wind farm, wherein, for the purpose of parameterizing an atmospheric turbulence of at least one wind turbine of the wind farm, a wind speed measurement is carried out, wherein the wind speed measurement is carried out continuously and in real time at a specific altitude of the wind turbine, the wind speed measurement is used to generate a data stream which is combined with the data record from meteorological data, wind speed measurements at specific other altitudes are additionally used to form the data stream, the wind speed measurements at the specific other altitudes describe a local wind shear, and the wind speed measurements and the meteorological data are transferred into a computer system for the purpose of being used to model a numerical weather prediction used for the prediction.

### SUMMARY

Aspects of the present disclosure are directed to predicting the wind conditions prevailing at a location of the wind turbine as reliably as possible.

According to the present disclosure, the object is achieved by a method according to claim 1. Further embodiments are proposed in the dependent claims.

According to a first aspect of the present disclosure, a method for providing wind data at a prediction location is provided, comprising: providing training data sets for a plurality of installation locations for wind turbines, in particular comprising training data sets from public databases, preparing the training data sets for machine learning by transforming the training data sets into features, training a prediction model for predicting at least one statistical wind condition at a prediction location on the basis of the features, obtaining a target prediction location, in particular from a CRM system, predicting the at least one statistical wind condition at the target prediction location using the trained prediction model, and providing wind data comprising the predicted at least one statistical wind condition, in particular providing the wind data to the CRM system.

“Machine learning” is a generic term for the “artificial” generation of knowledge from experience: an artificial system learns from examples and can generalize them after the end of the learning phase. For this purpose, algorithms in machine learning, also referred to as “machine learning algorithms”, build up a statistical model which is based on training data and which is tested against the test data. This means that the examples are not simply learned from the training data by heart, but rather patterns and laws are recognized in the training data. Thus, the system can also assess unknown data.

Providing training data sets comprises in particular any type of digital data exchange, in particular obtaining, retrieving and reading data from the Internet. For example, training data sets are provided from public databases.

In this case, the training data sets comprise in particular measured and/or derived values for a wide variety of wind parameters at a plurality of installation locations for wind turbines. In one example, the values for wind parameters contained in the training data sets are provided with location information about the location at which they were measured or for which they were determined. It is thus possible to assign a value of a wind parameter from the training data sets to a specific location. Furthermore, the training data sets comprise in particular average values and/or extreme values for wind parameters at a location measured or determined over a certain period of time, for example one year, five years, ten years, up to 50 years.

The training data sets may comprise measured and/or determined wind parameters on wind turbines. These wind parameter values were measured for example by sensors on a wind turbine or determined on the basis of measured auxiliary variables for the location of a wind turbine. Such data have the advantage that they comprise values for parameters which are particularly important for the operation of a wind turbine. Furthermore, these data thereby relate to a particularly relevant height above the ground, namely the height at which a rotor of a wind turbine is located. Moreover, these data have a particularly accurate location information, since the location of the wind turbine is known. The outlay for preparing the training data sets is thereby reduced and the accuracy of the prediction is optimized. These data from wind turbines originate in particular from internal, non-public databases.

As installation location for a wind turbine, any location is assumed at which a wind turbine could potentially be erected or a wind turbine has already been erected.

Preparing the training data sets for machine learning by transforming the training data sets into features comprises in particular combining and preparing a multiplicity of data from different databases. In this case, the data is transformed into values of individual features. The number of features is not restricted in this case, but can vary depending on the algorithm based on machine learning, ML algorithm. In particular, some features are predefined while others can be determined on the basis of the available data. For this purpose, a further already trained ML algorithm may be used.

In the context of the present disclosure, a feature is a characteristic on the basis of which data can be sorted, for example a parameter. More precisely, a feature is an individual measurable property or a characteristic of a phenomenon. The selection of informative, differentiated and independent features is a decisive element of effective algorithms in pattern recognition, classification and regression. Features are generally numerical, but can also comprise structural elements such as character strings and graphs.

Conceivable features in the context of the present disclosure are, for example, height above normal zero, terrain category, terrain condition, wind load zone, climate zone, average precipitation, average temperature, extreme temperatures, temperature fluctuations, plant growth in an area around the prediction location, occurrence of extreme weather situations and many more. It should be emphasized that these features, on the basis of which the ML algorithm recognizes correlations of the target prediction location with learned data, are not necessarily wind parameters or meteorological parameters, as can be recognized from the examples of purely geographical parameters such as terrain category or height above normal zero. The ML algorithm according to the present disclosure is accordingly capable, in particular in an exemplary embodiment, of predicting wind data for a target prediction location for which the ML algorithm has no meteorological data whatsoever.

In the context of the present disclosure, a prediction model is, in particular, an ML algorithm or a neural network. The prediction model is trained on the basis of the features with regard to the accuracy of the prediction of at least one statistical wind condition at a prediction location. The prediction model is trained in such a way that it determines at least one statistical wind condition at the location on the basis of a location as input via the features of the training data sets on the basis of the wind parameter data in the training data sets. Since a corresponding measured or determined value for this at least one statistical wind condition may be contained in the training data sets, the result of the prediction model can be compared with the actually recorded values during the training. In this case, the aim is to minimize a deviation of the result of the prediction model from the actually recorded data. In particular, the prediction model is likewise trained for reproducibility, with the result that it always arrives at the same result in a trained state without changing the input and the training data.

In particular, the prediction model is trained to use the smallest possible number of features for determining an average wind speed and a turbulence intensity at a prediction location. In this regard, it is conceivable, for example, to predefine a certain number of features or predefine certain individual features for a prediction model in an untrained state. During the training, it is possible for the prediction model to change the number of features in order to be able to make a more accurate prediction. It is likewise conceivable for the prediction model to replace certain features by others during the training in order to optimize the prediction accuracy and/or to keep the prediction model as compact as possible.

In a trained state, the prediction model determines an average wind speed and a turbulence intensity for a prediction location as input on the basis of a fixed selection of features which was optimized during the training.

The prediction model is trained, in particular, to provide selection rules on the basis of features, on the basis of which a prediction location is classified. In this case, it is possible to set up one or several selection rules per feature. From the classification on the basis of the selection rules, the prediction model draws conclusions about possible values of the at least one statistical wind condition. If the selection rules are run through in sequence, the prediction model always delimits possible prediction values per selection rule further and further until the prediction model determines an accurate prediction value for the at least one statistical wind condition. Depending on the desired accuracy of these prediction values, the prediction model possibly requires more selection rules and therefore more features; the more accurate the desired prediction value of the prediction model, the more selection rules the prediction model requires.

The prediction model may be trained in such a way that it provides precise predictions for the desired wind parameters within a few milliseconds in a trained state. The entire process including loading data from databases, calculating the features and predicting the prediction model is thereby possible within a specific time period, in particular a few minutes, for example 30 min, 20 min, 10 min, 5 min or 2 min.

Obtaining a target prediction location comprises any type of digital communication as well as manual input. In particular, a target prediction location is obtained from a CRM system. The abbreviation CRM stands for customer relationship management. A CRM system is used for systematic design of the customer relationship processes and comprises the documentation and management of customer relationships. For example, the locations of the wind turbines of a customer can be read from the CRM system. It is likewise possible via the CRM system to obtain possible locations for new wind turbines for example from a customer request.

The target prediction location is used as input into the trained prediction model. In particular, a latitude and a longitude are used as coordinates of the target prediction location as input. In one example application of a method according to the present disclosure, the target prediction location is not part of the training data on the basis of which the ML algorithm was trained, at least not in such a way that a measured value for the wind parameter to be predicted is present for the target prediction location.

The prediction of the at least one statistical wind condition at the target prediction location using the trained prediction model takes place on the basis of the fixed selection of features of the trained prediction model.

In particular, the trained prediction model determines a value for the target prediction location for each feature of the fixed selection of features. On the basis of these values, the target prediction location is classified for each feature. As a result, the possible values for the at least one statistical wind condition are restricted further and further from feature to feature until finally an output value for the predicted at least one statistical wind condition is provided. The trained ML algorithm thus recognizes, in particular, correlations between the values of the features of the prediction location and values of the wind data to be predicted.

For the determination of the values of the features for the target prediction location, the trained ML algorithm may be provided with geographical data, for example topographic maps, as well as further data, such as, for example, meteorological data, weather maps, data on annual or average precipitation, temperature and/or air density. For example, the trained ML algorithm has data which enable it to determine a value for each of the fixed selection of features and each of the features for the target prediction location.

The precise procedure of the trained prediction model in this classification on the basis of the features can differ between different embodiments of the prediction model, for example depending on which ML algorithm or which neural network forms the basis of the prediction model.

Providing wind data comprising the at least one statistical wind condition comprises in particular providing the wind data to the CRM system.

The wind data is not restricted in this case to the predicted at least one statistical wind condition, but can also contain further values for wind parameters which were determined, for example, on the basis of the at least one statistical wind condition. It is likewise conceivable for the wind data to comprise further values for wind parameters which were determined on the basis of the target prediction location. For example, it is possible to approximate an air density at the target prediction location by means of topographic maps.

The provided wind data can be taken into account, for example, in the planning of a wind turbine, since conclusions about an expected yield of the wind turbine can be drawn from these data.

The method according to the present disclosure has the advantage that no measurements at the planned location are necessary to estimate a potential yield of a planned wind turbine. Firstly, this saves time for setting up measuring instruments at the location. Secondly, the method reduces the error potential of predictions, since, for example, no data transmission from the measuring instrument into evaluation software is necessary and also no measurement errors can occur. Moreover, the method accelerates the estimation process, since the measurements at potential locations for wind turbines are usually carried out over a plurality of months up to over one or more years, in order to record as many as possible of all wind conditions occurring at the location.

According to a first advantageous embodiment of the first aspect of the present disclosure, the at least one statistical wind condition comprises an average wind speed and a turbulence intensity.

The predicted average wind speed is, in particular, the average wind speed within one year. The predicted turbulence intensity is, in particular, an ambient turbulence intensity for different wind speed ranges, for example for a wind speed of 15 m/s.

According to one example, the at least one statistical wind condition comprises in addition to the average wind speed and the turbulence intensity further statistical wind conditions, in particular an average wind shear, a Weibull k-parameter and/or extreme wind speeds over a time period of 10 min or extreme wind speeds over a time period of 3 s within 50 years.

Apart from the predicted average wind speed and the predicted turbulence intensity, further statistical wind conditions, such as the average wind shear, the Weibull k-parameter and extreme wind speeds for 10 minutes and/or 3 s within 50 years, may be predicted for a target prediction location.

The average wind shear relates, in particular, to air layers at an altitude at which the rotor of the wind turbine is operated.

The Weibull k-parameter is a measure of the shape of the wind speed distribution: the higher k is, the lower is the scattering of the wind speeds.

In particular, extreme wind speeds are predicted which last over a time period of 10 min and/or last over a time period of 3 s. In this case, the first relate to extremely strong wind speeds which act on the wind turbine over a longer time period of 10 min and the latter relate to extremely strong wind speeds, for example gusts, which act on the wind turbine only over a shorter time period of 3 s. According to the standard consideration of extreme wind speeds in the field of wind energy, extreme wind speeds are predicted for a time period of 50 years.

According to a further advantageous embodiment of the first aspect of the present disclosure, the wind data at the target prediction location is further predicted by indicating a target hub height of the wind turbine.

The prediction model obtains the target hub height as second input parameter next to the target prediction location.

In addition to the target prediction location and in particular the target hub height, the prediction model may require no further input parameters in order to predict the at least one statistical wind condition.

In this case, the prediction model predicts the at least one wind condition as a function of a height above the ground or the sea level, depending on whether the target prediction location is located on land or at sea. Particularly relevant wind data can thus be output by indicating a target hub height.

In this case, the target hub height relates to the planned height of the hub of a planned wind turbine or to the height of the hub of an already existing wind turbine above the earth's surface. On land, the earth's surface represents the ground; in offshore installations, the earth's surface represents the sea level, in particular normal zero.

The hub height allows conclusions about the heights at which the rotor of the wind turbine is operated. For example, the heights of the air layers with which the rotor blades interact aerodynamically can be determined on the basis of the hub height and length of the rotor blades. An average wind speed and turbulence intensity is particularly relevant for the yield of the wind turbine precisely in these air layers.

It is thus advantageous to predict wind data by indicating a target hub height for a prediction of the yield of a planned wind turbine.

According to a further advantageous embodiment of the first aspect of the present disclosure, the prediction location is characterized by a plurality of location-specific markers, called features.

By characterizing the prediction location into a plurality of location-specific markers, the prediction model classifies the prediction location with regard to learned correlations between location-specific markers, such as, for example, height above normal zero, terrain category and wind load zone, and average wind speed and turbulence intensity.

According to one example embodiment, the location-specific markers are extracted from publicly accessible resources, in particular from European Reanalysis (ERA5), New European Wind Atlas (NEWA), Global Wind Atlas (GWA) and Shuttle Radar Topography Mission (SRTM30).

This makes it possible to provide an extensive data set of measured and/or determined wind parameters at a wide variety of locations at a wide variety of heights. In particular, data with regard to different ambient conditions, such as, for example, temperature, precipitation and solar radiation, are also recorded.

Training data sets for training the prediction model are extracted from this extensive data set. Alternatively, the entire data set can also represent a training data set for the prediction model.

These training data sets are then prepared for machine learning by transforming the training data sets into features.

According to one example embodiment, the location-specific features are calculated using a time series data set, in particular in hourly resolution, of weather physical variables, in particular the location-specific features are formed by a calculation of mean values, standard deviation, normalization and maximum values of the weather physical variables.

In particular, the location-specific features are calculated using a time series data set of weather physical variables with a grid resolution of 0.1°. The grid resolution of 0.1° relates to 0.1° latitude and 0.1° longitude. The grid of the time series data set thus has an at least two-dimensional extent. Since at least the 0.1° longitude changes in actual distance in kilometers depending on the position on the Earth's sphere, the grid resolution in kilometers is also variable. For longitude and latitude in Europe, the grid resolution is approximately 31 km.

In particular, resource from the field of weather reanalysis (ERA5) with detailed information on weather physical variables is available in hourly resolution with a grid resolution of 0.1°. Characteristic markers are formed from this time series data set in particular by calculation of the mean values, standard deviation, normalization and maximum values.

According to a further advantageous embodiment of the first aspect of the present disclosure, the features further comprise a direction-dependent wind speed distribution, called wind rose.

The inclusion of a direction-dependent wind speed distribution increases the accuracy of the prediction of the average wind speed and of the turbulence intensity.

According to a preferred variant of the above embodiment, the wind rose comprises a plurality of sectors, each comprising at least 30° and/or the wind rose does not contain at least one directional sector.

In this embodiment, the wind rose is thus divided in particular into 12 sections of 30°. This results in a very accurate direction-dependent wind speed distribution, since up to 12 different wind directions are considered.

It is a finding of the present disclosure that the consideration of an incomplete wind rose, i.e. a wind rose which does not contain at least one directional sector, already has a positive effect on the accuracy of the prediction of the average wind speed and of the turbulence intensity.

According to one example embodiment, the wind rose comprises a plurality of sectors, each comprising at least 600 and/or the wind rose does not contain at least one directional sector.

In this embodiment, the wind rose is thus divided in particular into 6 sections of 60°. This results in an accurate direction-dependent wind speed distribution, since up to 6 different wind directions are considered.

The consideration of only 6 different wind directions instead of, for example, 12 has a positive effect on the prediction model in such a way that a large part of the information from the 12 sectors of 30° can be used with, for example, 6 sectors, wherein this is made available to the prediction model by a few features. This is positive, since the model accuracy decreases again as a result of an excessively large number of features.

It is a finding of the present disclosure that the consideration of an incomplete wind rose, i.e. a wind rose which does not contain at least one directional sector, already has a positive effect on the accuracy of the prediction of the average wind speed and of the turbulence intensity.

According to one example embodiment, the wind rose comprises a plurality of sectors, wherein the wind rose comprises a larger number of sectors in a main wind direction than in a wind direction other than the main wind direction.

In this case, a main wind direction is determined in particular on the basis of data which extend over a time period of up to one year. The main wind direction is in particular a wind direction which occurs at the wind turbine over a greatest time period, compared with all other occurring wind directions at the prediction location, or an average wind direction.

It is a finding of the present disclosure that it is advantageous to apply a higher resolution of the direction-dependent wind speed distribution in this main wind direction than in other wind directions, since the accuracy of the prediction can therefore be increased.

In this context, the higher resolution due to a larger number of sectors of the main wind direction in particular does not extend to the main wind direction, which is determined for example with an accuracy of 1°, alone, but rather may extend over a range of up to ±30° with respect to the main wind direction. This has a positive effect on the accuracy of the prediction.

According to a further advantageous embodiment of the first aspect of the present disclosure, the training data sets comprise wind speeds at different altitudes and the features comprise a wind shear calculated from the wind speeds at different altitudes.

Resources specifically provided for wind energy are also used (GWA & NEWA) which provide some averaged values for relevant variables such as average wind speed and distribution and air density in a grid resolution of 250 m or less. For GWA, NEWA and ERA5, wind speeds at different altitudes are used to calculate a wind shear as markers.

It has been recognized that the accuracy of the prediction of the average wind speed and of the turbulence intensity increases when a wind shear is determined as a feature.

According to a further advantageous embodiment of the first aspect of the present disclosure, the training data sets comprise altitude information, in particular based on satellite measurements, around the prediction location, wherein the features comprise quantities derived from altitude information.

Such quantities derived from the altitude information are, for example, an altitude above normal zero and/or an air density estimated on the basis of the altitude information.

According to one example embodiment, the features derived from altitude information comprise an altitude difference between the installation location and a reference location.

The reference location is, in particular, a design altitude for which the wind turbine was designed. Differences between the design altitude and the actual altitude of the wind turbine at its location can have negative effects on the yield and/or loads acting on the wind turbine. An inclusion of this altitude difference thus makes it possible to more accurately estimate the potential yield of a wind turbine at an installation location.

According to one example embodiment, the reference location is arranged at a predetermined distance, in particular 500 or 3000 m, in a) a predetermined direction, in particular west, northwest or north direction, or b) as mean value of the altitude of all locations with the predetermined distance.

In one example, the reference location is arranged at a predetermined distance in a direction ±30° from the main wind direction, and/or at a predetermined distance in the main wind direction.

In particular, elevations, for example mountains in the immediate vicinity of the wind turbine, which possibly cast a wind shadow onto the wind turbine in specific wind directions, can thus also be included in the prediction. This increases the accuracy of the prediction.

According to one example embodiment, the features derived from altitude information comprise a surface roughness.

The surface roughness is a component of the surface texture. It is quantified by the deviations in the direction of the normal vector of a real surface from its ideal shape. If these deviations are large, the surface is rough, if they are small, the surface is smooth.

This surface roughness can have an effect on the turbulence intensity at the location of the wind turbine and for example cause more and/or stronger turbulences. An inclusion of this surface roughness makes it possible to more accurately predict.

According to a further advantageous embodiment of the first aspect of the present disclosure, transforming the training data sets into features comprises: transforming the training data sets into a subset of the available features, in particular into a subset with at most 25 features.

This is a so-called feature subset selection (FSS), short feature selection, which is an approach from machine learning in which only a subset of the available features is used for machine learning. FSS is advantageous because it is technically very complicated in some cases to include all features or because there are differentiation problems if a large number of features but only a small number of data sets are present or in order to avoid over adaptation of the model, see bias-variance tradeoff.

According to a further advantageous embodiment of the first aspect of the present disclosure, the prediction model comprises a decision tree, in particular a random forest and/or a boosted forest algorithm.

In particular in the case of a random forest algorithm and/or a boosted random forest algorithm, the prediction model comprises a plurality of decision trees.

These decision trees may be ordered, directed trees which serve to represent decision rules. The graphical representation as a tree diagram illustrates hierarchically successive decisions.

In this case, a decision tree may consist of a root node, any desired number of inner nodes and at least two leaves. There may be one path between two nodes. In this case, each node, including the root node, represents a logical rule and each leaf represents an answer to the decision problem. In order to obtain a classification of an individual data object, one goes down from the root node along the tree. At each node, at least one attribute is queried and a decision is made about the selection of the following node. This procedure is continued until one reaches a leaf. The leaf corresponds to the classification. A tree may contain rules for answering precisely one question. The logical rule may be a mathematical operation with regard to an attribute, in particular the checking whether a certain attribute value lies above or below a threshold value. It is likewise possible for a logical rule to relate to a plurality of attributes, that is to say to assign a data object to a further node on the basis of the attribute values of a plurality of different attributes. In this case, it is likewise possible for the logical rule to relate to mathematical operations comprising a plurality of attributes in a mathematical operation, and for the plurality of attributes to be checked by the mathematical operation, for example on the basis of a threshold value.

In the case of a binary decision problem, there are only two answers for each logical rule, that is to say each node. However, the method according to the present disclosure is not restricted to binary decision trees, but each node of a decision tree can have any desired number of answers to the logical rule of the node.

A data set is used for forming a decision tree. This data set may contain a multiplicity of individual data objects which each have one or more identical attributes (e.g., with different attribute values) and can be classified on the basis of these attribute values. In addition, the classification of each data object is known. For a node of the decision tree, a logical rule is set up on the basis of one or more attributes of the data objects on the basis of the individual attribute values. On the basis of this logical rule, the data objects of the data set can be divided into two or more states at each node. In this case, a state indicates a subset of data objects of the set of data objects contained in the data set. A state thus in turn describes a set of individual data objects, in particular one or more data objects.

For the determination of a logical rule of a node, it is advantageous to consider the information gain by dividing the data set by the logical rule. For this purpose, for example, the entropy provides a calculable measure. The entropy may be defined as the expected value of the information content of a state:

$$H = E [ I ] = {\sum }_{z ∈ Z} {p}_{z} I ( z ) = - {\sum }_{z ∈ Z} {p}_{z} {log}_{2} {p}_{z}$$

In this case, H is the entropy, E is the expected value, here from the information content I, where I(z)=−log₂ p_{z} indicates the information content of an event z which occurs with the probability p_{z}. Z is the set of all different events of a state.

An event z may be a specific attribute value of an attribute of a data object. In order to determine the probability p_{z} with which the event z occurs, the different attribute values of this attribute of the data objects of a state are considered. The probability p_{z} of an event z indicates how probable it is to draw a data object with the specific attribute value of the event z in the case of a random selection of a data object from the data objects of the state. The entropy can thus be determined for a state comprising one or more data objects.

In order to calculate the information gain by dividing a set of individual data objects on the basis of a logical rule, the entropy of the initial state of the set of individual data objects before the division on the basis of a logical rule and the individual entropies of the states arising as a result of the division are considered. In this case, for example, the following formula provides a measure of the information gain:

$$IG = H ( initial state ) - {\sum }_{i = 0}^{n} {w}_{i} H ( {state}_{i} )$$

In this case, IG is the information gain, H is the entropy, n is the number of all different states after dividing the set of individual data objects by applying the logical rule and wᵢ is a weighting of the state stateᵢ on the basis of the number of individual data objects of the state compared with the number of individual data objects of the initial state, in particular:

$${w}_{i} = \frac{number of individual data objects of the state i}{number of individual data objects of the initial state}$$

It is thus possible to calculate a measure of a logical rule and to compare different logical rules with one another. The greater the information gain after dividing the set of individual data objects by applying the logical rule, the better is the logical rule.

An example logical rule can thus be determined for each node by optimizing the information gain. In this case, in particular the information gain is determined and compared for each of a multiplicity of possible logical rules. An optimization of the information gain in the determination of a logical rule for a node has a positive effect on the size of the decision tree and thus on the computing power to be expended when running through the decision tree. A decision tree gains compactness by means of optimized logical rules and leads more quickly to a result for the classification of a new data object.

A decision tree according to the method according to the present disclosure thus comprises one or more logical rules, on the basis of which a target prediction location can be classified on the basis of the features. This classification results in a determined average wind speed and a determined turbulence intensity at the target prediction location.

In one example, a machine learning algorithm is trained with a data set for the method according to the present disclosure. The data set may contain measured and/or determined wind parameters at a wide variety of locations at a wide variety of heights.

The machine learning algorithm may then create one or more decision trees on the basis of the data set with the aim of enabling a classification in the form of the at least one statistical wind condition, in particular a predicted average wind speed and a predicted turbulence intensity, on the basis of the information about the target prediction location in the form of features.

In this case, the logical rules are selected on the basis of the features. In this case, a feature takes the place of an attribute according to the above explanation. Logical rules relating to features which result in an information gain per node are selected. This selection of logical rules is additionally optimized, with the result that a decision tree which is as compact as possible and is capable of outputting precise predictions is produced.

In particular, the method comprises a random forest algorithm.

A random forest algorithm is a machine learning algorithm which consists of a plurality of uncorrelated, in particular a multiplicity of uncorrelated, decision trees. In this context, uncorrelated means that the decision trees were formed independently of one another according to, in particular, different logical rules and data sets. All decision trees have grown under a specific type of randomization during the learning process. The learning process comprises, in particular, the process of forming a decision tree. The individual trees are then combined to form an ensemble, the random forest. The results of the individual trees are combined in the ensemble with an aggregation function. An aggregation function from: mean value, median or majority choice may be used, but the present disclosure is not restricted to this aggregation function, but also includes further aggregation functions.

For the learning process of the random forest algorithm, a data set, as already described, comprising information about measured and/or determined wind parameters at a wide variety of locations at a wide variety of heights is used. The features transformed therefrom may each represent an attribute and the values thereof each represent a corresponding attribute value.

In one example, at a first step of the learning process of the random forest algorithm, a multiplicity of second data sets, also partial data sets, are created from the original data set, the initial data set. For this purpose, a number of individual data objects, for example individual features, with the corresponding attribute values is copied from the initial data set per partial data set. Which data objects are chosen for the respective partial data sets is determined randomly.

It is advantageous if the total number of individual data objects in each of the partial data sets corresponds to the number of individual data objects in the initial data set. In this case, a data object with corresponding attribute values can be copied into one or more of but also no partial data set. In one example, each individual data object with its attribute values is copied at least into one partial data set. It is likewise possible for an individual data object with its attribute values to be copied repeatedly into the same partial data set. In particular, such a data processing process is a bootstrapping process.

In one example, at a second step, the decision trees of the random forest algorithm are now formed. A corresponding process has already been explained further above. The difference here is that the initial data set is not used for the determination of example logical rules, but rather the partial data sets. In one example, an uncorrelated decision tree is formed per partial data set. In this case, not all individual data objects present in this partial data set may be used for the learning process of the decision tree. The individual data objects which are used for the determination of example logical rules may be randomly selected. This reduces the probability of a possible correlation between the individual decision trees and has a positive effect on the accuracy of the algorithm. Assuming that the same data objects are used for the formation of all decision trees, the probability increases that identical example logical rules occur in different decision trees, since the optimization process which attempts to find an example logical rule uses the same data set. This promotes the correlation between the trees and leads to less accurate results, since a possible path of the classification of the correlated decision trees gains weight in the aggregation function by means of the correlated decision trees in comparison with the many other paths of the uncorrelated decision trees. This also applies if a partial data set is used for the formation of a plurality of decision trees.

In one example, the number of individual data objects which are used for the determination of example logical rules is an integer in the region of the root from the number of individual data objects in the initial data set. In the region here means that the absolute value of the root is mathematically correctly rounded to the next integer and the number of individual data objects which are used for the determination of example logical rules deviates from the rounded number, by for example ±10, ±5, ±3, ±1, etc. Alternatively, it is likewise advantageous for this calculation of the number of individual data objects which are used for the determination of example logical rules to use the logarithm function instead of the root function.

For the classification of a target prediction location, the decision trees of the multiplicity of uncorrelated decision trees formed in this way are run through with the information of the features of the target prediction location, for example, height above normal zero, terrain condition, average ambient temperature, climate zone. Each individual decision tree classifies the target prediction location. As already described, the individual classifications of the individual decision trees are combined and evaluated with the aid of an aggregation function. Additionally or alternatively, a target prediction location is determined on the basis of a regression of the random forest algorithm including aggregation function.

A boosted random forest algorithm combines an algorithm generally also known as gradient boosting with a random forest algorithm.

In the case of the boosted random forest algorithm, at least one of the decision trees is subjected to an additional gradient boosting.

Gradient boosting is a machine learning technique which is based on boosting in a functional space, wherein the target is pseudo-residues and not the typical residues which are used in traditional boosting. It provides a prediction model in the form of an ensemble of weak prediction models, i.e. models which make only a few assumptions about the data, which are generally simple decision trees. If a decision tree is the weak learner, the resulting algorithm is called gradient boosted trees or boosted random forest algorithm; it represents a further development of the random forest algorithm and generally exceeds the latter. A gradient boosted trees model is constructed in stages as in the case of other boosting methods, but generalizes the other methods by making it possible to optimize any desirable differentiable loss function.

It is likewise possible to base the prediction model on other algorithms, for example neural networks or support vector machines. However, the random forest algorithm or the boosted random forest algorithm have proved to be superior to these other algorithms in the context of the present disclosure.

According to a further advantageous embodiment of the first aspect of the present disclosure, the provided wind data comprise a predicted average wind speed with an accuracy of 0.5 m/s.

In this embodiment, the prediction model was trained on an accuracy of the prediction of an average wind speed as a statistical wind condition of 0.5 m/s.

According to a further advantageous embodiment of the first aspect of the present disclosure, further comprising: load prediction of the wind turbine on the basis of the provided wind data, and/or prediction of an annual yield of the wind turbine on the basis of the provided wind data.

In this case, the provided wind data is transferred into a load model which creates a load prediction for the wind turbine on the basis of the wind data. In particular, in this case, predictions are created for different loads which act on the wind turbine, such as blade loads and tower loads. In one example, predictions are also created for torsional loads, pivoting loads and bending moments of the rotor blades of the wind turbine.

In one example, the load model takes into account types of individual components of the wind turbine, for example a specific rotor blade type for which the wind turbine is designed, in the load prediction.

To predict an annual yield of the wind turbine, the wind data is transferred into a power model which creates a prediction of the annual yield of the wind turbine on the basis of the wind data.

In one example, the power model takes into account types of individual components of the wind turbine, for example a specific rotor blade type for which the wind turbine is designed, in the prediction of the annual yield.

According to one example embodiment, the wind turbine is part of a wind farm comprising a plurality of wind turbines and the method further comprises: optimizing a wind farm configuration of the wind farm on the basis of the load prediction and/or the prediction of the annual yield of the wind turbine.

The wind farm configuration describes in particular the types and locations of the individual wind turbines of the wind farm. Types of the wind turbine comprise, for example, low-wind and high-wind wind turbines.

The wind farm configuration is optimized in particular in such a way that the type and/or the location is changed for one or more wind turbines, with the result that a potential overall yield of the wind farm is increased and/or potential wear of individual wind turbines is reduced.

According to one example embodiment, the method further comprises: prediction of a life span and/or of maintenance intervals of at least one component of the wind turbine on the basis of the load prediction and/or the prediction of the annual yield of the wind turbine.

In the context of this present disclosure, components of the wind turbine are to be understood as meaning, in particular, tower, nacelle, rotor blade bearing and rotor blades.

For example, maintenance intervals and/or life span of the rotor blades can be predicted on the basis of the load prediction and/or the prediction of the annual yield of the wind turbine.

### BRIEF DESCRIPTION OF THE SEVERAL VIEWS OF THE DRAWINGS

Further advantages and embodiments are described below with reference to the figures. The figures show:

FIG. 1 schematically and by way of example a wind turbine;

FIG. 2 schematically and by way of example a wind farm,

FIG. 3 schematically and by way of example a sequence process of a method according to the present disclosure,

### DETAILED DESCRIPTION

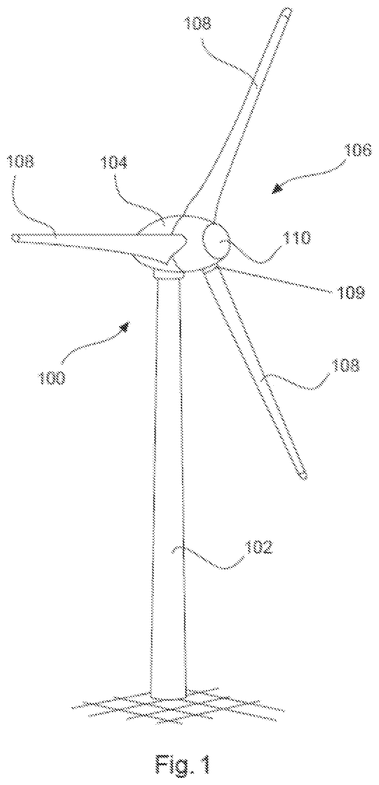

FIG. 1 shows a schematic representation of a wind turbine according to the present disclosure. The wind turbine 100 has a tower 102 and a nacelle 104 on the tower 102. An aerodynamic rotor 106 with three rotor blades 108 and a spinner 110 is provided on the nacelle 104. During the operation of the wind turbine, the aerodynamic rotor 106 is set into a rotational movement by the wind and thus also rotates an electrodynamic rotor of a generator which is coupled directly or indirectly to the aerodynamic rotor 106. The electrical generator is arranged in the nacelle 104 and generates electrical energy. The pitch angles of the rotor blades 108 can be changed by pitch motors at the rotor blade roots 109 of the respective rotor blades 108.

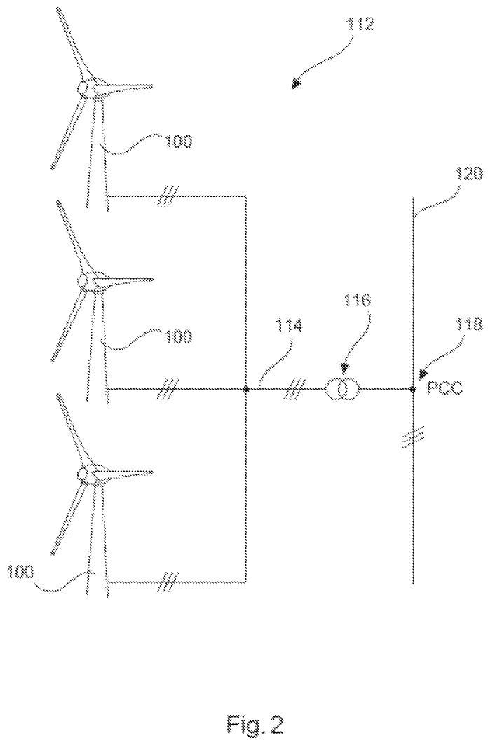

FIG. 2 shows a wind farm 112 with, by way of example, three wind turbines 100 which can be identical or different. The three wind turbines 100 are thus representative of basically any desired number of wind turbines of a wind farm 112. The wind turbines 100 provide their power, namely in particular the generated power, via an electrical farm network 114. In this case, the respectively generated currents or powers of the individual wind turbines 100 are added up and a transformer 116 is usually provided which steps up the voltage in the farm in order then to feed it into the supply network 120 at the feed point 118, which is also generally referred to as PCC. FIG. 2 is only a simplified representation of a wind farm 112. For example, the farm network 114 can be configured differently, in that, for example, a transformer is also present at the output of each wind turbine 100, in order to mention just another exemplary embodiment.

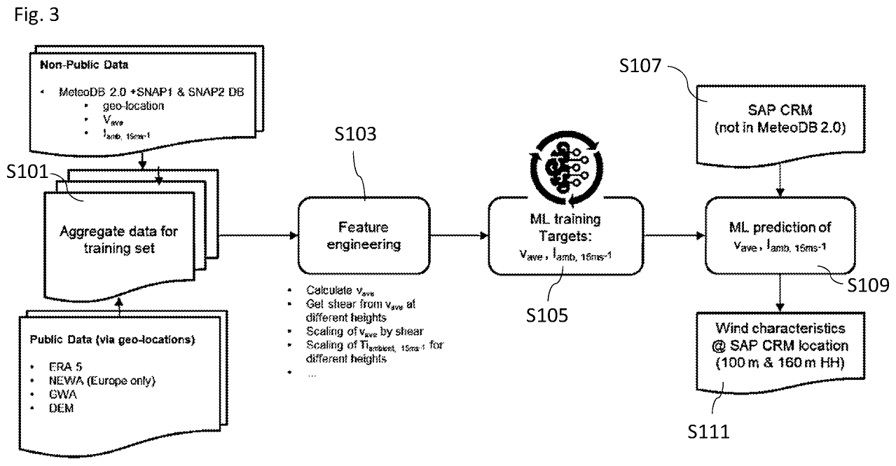

FIG. 3 shows a sequence process of a method according to the present disclosure. In step S101, training data sets for a plurality of installation locations for wind turbines are provided. In this embodiment, the training data sets contain data from public databases, more precisely from ERA 5, NEWA, GWA and DEM. However, the training data likewise comprise non-public data from internal databases which relate to measurements on wind turbines. For this purpose, the data contain the location of the respective wind turbine and wind parameters measured on the wind turbine.

In step S103, the training data sets for machine learning are prepared by transforming the training data sets into features. In this case, the features are developed in a wide variety of ways from the training data sets. An average wind speed vₐᵥₑ is calculated, for example, for a plurality of locations and a plurality of altitudes. A wind shear is determined on the basis of the average wind speeds vₐᵥₑ at different altitudes. The average wind speed can be scaled on the basis of this determined wind shear. In this embodiment, a turbulence intensity Ti_{ambient, 15 ms-1} for an average wind speed of 15 m/s is also scaled for different altitudes. Moreover, a plurality of further features is developed which map the environmental and measurement conditions of the data of the training data sets.

In step S105, an ML algorithm is trained on the basis of the training data sets prepared in step S103 for the prediction of an average wind speed vₐᵥₑ and a turbulence intensity I_{amb, 15 ms-1} for an average wind speed of 15 m/s. In this case, the training can contain a plurality of iterations. By comparison with data from the training data sets, the output results of the ML algorithm are checked until this outputs results with deviations in a predetermined range, and/or exact precise results reproducibly and within a predefined time period. The aim is to obtain a precise prediction of the desired wind parameters within a few minutes after input of a prediction location.

In step S107, a target prediction location from an SAP CRM system is provided. This is, for example, a location at which a customer wants to set up a new wind turbine. The target prediction location is transferred to the trained ML algorithm as input in the form of coordinates in latitude and longitude, with the result that it can begin with the prediction of the desired wind parameters on which it was trained.

In step S109, the trained ML algorithm predicts the average wind speed vₐᵥₑ and the turbulence intensity I_{amb, 15 ms-1} for an average wind speed of 15 m/s at the target prediction location.

In step S111, wind data comprising the predicted average wind speed vₐᵥₑ and the turbulence intensity I_{amb, 15 ms-1} for an average wind speed of 15 m/s are provided for the SAP CRM system. In this exemplary embodiment, wind data for heights of 100 m and 160 m above the earth's surface were provided at the target prediction location.

### REFERENCE SIGNS

100 wind turbine
102 tower
104 nacelle
106 rotor
108 rotor blade
110 spinner
112 wind farm
114 farm network
116 transformer
118 feed point
120 supply network

1. A method for providing wind data at a location, comprising
providing training data sets for a plurality of installation locations for wind turbines, wherein the training data sets are obtained from public databases,
preparing the training data sets for machine learning by transforming the training data sets into features,
training a prediction model for predicting at least one statistical wind condition at the location based on the features,
obtaining a target location, in particular from a Customer Relationship Management (CRM) system,
predicting the at least one statistical wind condition at the target location using the trained prediction model, and
providing wind data including the predicted at least one statistical wind condition to the wind data to the CRM system.

2. The method according to claim 1, wherein the at least one statistical wind condition comprises an average wind speed and a turbulence intensity.

3. The method according to claim 2, wherein the at least one statistical wind condition comprises in addition to the average wind speed and the turbulence intensity further statistical wind conditions including one or more of an average wind shear, a Weibull k-parameter, extreme wind speeds over a time period of 10 min, and extreme wind speeds over a time period of 3 s within 50 years.

4. The method according to claim 1, wherein the wind data at the target location is further predicted by indicating a target hub height of the wind turbine.

5. The method according to claim 1, wherein the location is characterized by a plurality of location-specific features extracted from publicly accessible resources that include European Reanalysis (ERA5), New European Wind Atlas (NEWA), Global Wind Atlas (GWA) and Shuttle Radar Topography Mission (SRTM30).

6. The method according to claim 5, wherein the location-specific features are determined using a time series data set, with hourly resolution, of weather-related variables.

7. The method according to claim 1, wherein the features include a direction-dependent wind speed distribution.

8. The method according to claim 1, wherein the training data sets includes wind speeds at different altitudes and the features includes a wind shear determined from the wind speeds at different altitudes.

9. The method according to claim 1, wherein the training data sets include altitude information based on satellite measurements, around the prediction location, and
wherein the features are derived from altitude information that reflect an altitude difference between an installation location and a reference location.

10. The method according to claim 9, wherein the reference location is arranged at a predetermined distance in a) a predetermined direction, or b) as a mean value of corresponding altitude of all locations with the predetermined distance.

11. The method according to claim 9, wherein the features derived from the altitude information include a surface roughness.

12. The method according to claim 1, wherein transforming the training data sets into features comprises:
transforming the training data sets into a subset of the available features having at most 25 features.

13. The method according to claim 1, wherein the prediction model comprises at least one of a decision tree, a random forest, or a boosted forest algorithm.

14. The method according to claim 1, wherein the wind data includes a predicted average wind speed with an accuracy of 0.5 m/s.

15. The method according to claim 1, further comprising:
predicting a load of the wind turbine based on the wind data;
predicting an annual yield of the wind turbine based on the wind data;
predicting one or more of a life span and maintenance intervals of at least one component of the wind turbine based on at least one of the load and the annual yield of the wind turbine, wherein
the wind turbine is part of a wind farm that includes a plurality of wind turbines.

16. The method according to claim 6, wherein the location-specific features are formed based on one or more of mean values, standard deviation, normalization and maximum values of the weather-related variables.

17. The method according to claim 7, wherein the direction-dependent wind speed distribution includes a plurality of sectors each including at least 30° or at least 60°.

18. The method according to claim 7, wherein the direction-dependent windspeed distribution does not contain a directional sector.

19. The method according to claim 7, wherein the direction-dependent windspeed includes a larger number of sectors in a main wind direction than in a wind direction other than the main wind direction.

20. The method according to claim 15, further comprising:
optimizing a wind farm configuration of the wind farm based on at least one of the load or the annual yield of the wind turbine.
